(19) United States
(12) Patent Application Publication
(10) Pub. No.: US 2026/0339431 A1
(43) Pub. Date: Oct. 29, 2026

(54) FINAL VIEW MAPPING AND DISTORTION CORRECTION WITH EYE POSE CHANGES FOR VIDEO SEE-THROUGH MIXED REALITY OR OTHER APPLICATIONS

(71) Applicant: Samsung Electronics Co., Ltd., Suwon-si (KR)

(72) Inventor: Yingen Xiong, Mountain View, CA (US)

(21) Appl. No.: 19/575,378

(22) Filed: Mar. 23, 2026

Related U.S. Application Data
(60) Provisional application No. 63/796,959, filed on Apr. 29, 2025.

(51) Int. Cl. G06F 3/01; G06T 5/80; G06T 19/00

(52) U.S. Cl. CPC G06F 3/013; G06F 3/012; G06T 5/80; G06T 19/006

(57) ABSTRACT

A method includes obtaining, using at least one processing device of an electronic device, input data. The input data includes image data of a scene, eye tracking data, and head pose data. The method includes applying a distortion correction mapping to the image data based on the eye tracking data to generate final view frames for display. The method includes applying a viewpoint matching mapping between viewpoints of image data and viewpoints of a user's eyes based in part on the eye tracking data. The method includes correcting parallax error and registration error in the final view frames using the eye tracking data. The method includes correcting display lens geometric distortions and chromatic aberrations in the final view frames using the eye tracking data. The method includes processing the final view frames for display on at least one display device.

### CROSS-REFERENCE TO RELATED APPLICATION AND PRIORITY CLAIM

This application claims priority under 35 U.S.C. § 119(e) to U.S. Provisional Patent Application No. 63/796,959 filed on Apr. 29, 2025, which is hereby incorporated by reference in its entirety.

### TECHNICAL FIELD

This disclosure relates generally to imaging systems and processes. More specifically, this disclosure relates to final view mapping and distortion correction in video see-through mixed reality (MR) or other applications.

### BACKGROUND

Extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some MR systems can often seamlessly blend virtual objects generated by computer graphics with real-world scenes.

It is important that XR systems are able to produce final view frames that are accurate and acceptable to the user. Current systems, particularly head-mounted-device systems, cannot properly accommodate changes in the user's head position and eye position.

### SUMMARY

This disclosure relates to final view mapping and distortion correction in video see-through mixed reality (MR) or other applications.

In a first embodiment, a method includes obtaining, using at least one processing device of an electronic device, input data. The input data includes image data of a scene, eye tracking data, and head pose data. The method includes applying, using the at least one processing device, a distortion correction mapping to the image data based on the eye tracking data to generate final view frames for display. The method includes applying, using the at least one processing device, a viewpoint matching mapping between viewpoints of image data and viewpoints of a user's eyes based in part on the eye tracking data. The method includes correcting parallax error and registration error in the final view frames, using the at least one processing device and the eye tracking data. The method includes correcting display lens geometric distortions and chromatic aberrations in the final view frames, using the at least one processing device and the eye tracking data. The method includes processing, using the at least one processing device, the final view frames for display on at least one display device.

In a second embodiment, an electronic device includes at least one processing device configured to obtain input data. The input data includes image data of a scene, eye tracking data, and head pose data. The processing device is configured to apply a distortion correction mapping to the image data based on the eye tracking data to generate final view frames for display. The processing device is configured to apply a viewpoint matching mapping between viewpoints of image data and viewpoints of a user's eyes based in part on the eye tracking data. The processing device is configured to correct parallax error and registration error in the final view frames, using the eye tracking data. The processing device is configured to correct display lens geometric distortions and chromatic aberrations in the final view frames, using the eye tracking data. The processing device is configured to process the final view frames for display.

In a third embodiment, a non-transitory machine readable medium contains instructions that when executed cause at least one processor of an electronic device to obtain input data. The input data includes image data of a scene, eye tracking data, and head pose data. The instructions cause at least one processor to apply a distortion correction mapping to the image data based on the eye tracking data to generate final view frames for display. The instructions cause at least one processor to apply a viewpoint matching mapping between viewpoints of image data and viewpoints of a user's eyes based in part on the eye tracking data. The instructions cause at least one processor to correct parallax error and registration error in the final view frames, using the eye tracking data. The instructions cause at least one processor to correct display lens geometric distortions and chromatic aberrations in the final view frames, using the eye tracking data. The instructions cause at least one processor to process the final view frames for display.

Any single one or any combination of the following features may be used with the disclosed embodiments. Some embodiments can also include computing a change in interpupillary distance (IPD) and a change in eye relief corresponding to the eye tracking data, predicting a change between a first head pose when the image data is obtained and a second head pose when the final view frames are processed for display, where the prediction is based in part on the change in IPD and the change in eye relief, and producing the final view frames based on the predicted change between the first head pose and the second head pose.

In some embodiments, the input data further includes scene depth data. Some embodiments can also include computing a change in eye view depth based on the change in IPD, the change in eye relief, and the scene depth data, generating the viewpoint matching mapping between the viewpoints of the image data and the viewpoints of the user's eyes based on the change in the eye view depth, and applying the viewpoint matching mapping to the image data to generate the final view frames.

In some embodiments, correcting the parallax error and the registration error is based on the change in IPD, the change in eye relief, and the change in the eye view depth. In some embodiments, correcting display lens geometric distortions and chromatic aberrations in the final view frames is based on a distortion model comprising parameters stored on the electronic device. In some embodiments, the distortion model is modified according to the change in IPD and the change in eye relief.

Some embodiments can also include generating virtual objects by the electronic device and blending the generated virtual objects with the image data to generate the final view frames.

In some embodiments, the final view frames include corrected image data corresponding to the viewpoints of the user's eyes.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device according to this disclosure;

FIG. 2 illustrates an example high-level process for final view mapping and distortion correction for video see-through MR or other applications in accordance with this disclosure;

FIG. 3 illustrates a more detailed process for final view mapping with eye pose changes for video see-through MR or other applications in accordance with this disclosure;

FIG. 4 illustrates a more detailed process for dynamic final view correction with eye tracking for video see-through MR or other applications in accordance with this disclosure;

FIG. 5 illustrates a diagram of parameters for a passthrough pipeline with eye movement tracking in accordance with this disclosure;

FIG. 6 illustrates a diagram of head pose and eyeball poses with eye movement for use in final view frame generation in accordance with this disclosure;

FIG. 7 illustrates a process for mapping between the see-through frame to the final view frame in accordance with this disclosure;

FIG. 8 illustrates a diagram of creating a mapping in accordance with this disclosure;

FIG. 9 illustrates a process for performing dynamic parallax correction caused by eyeball movements in accordance with this disclosure;

FIG. 10 illustrates a diagram of dynamic parallax correction caused by eyeball movement in accordance with the disclosure; and

FIG. 11 illustrates an integrated process for final view mapping and distortion correction with eye pose changes for video see-through mixed reality or other applications in accordance with this disclosure.

### DETAILED DESCRIPTION

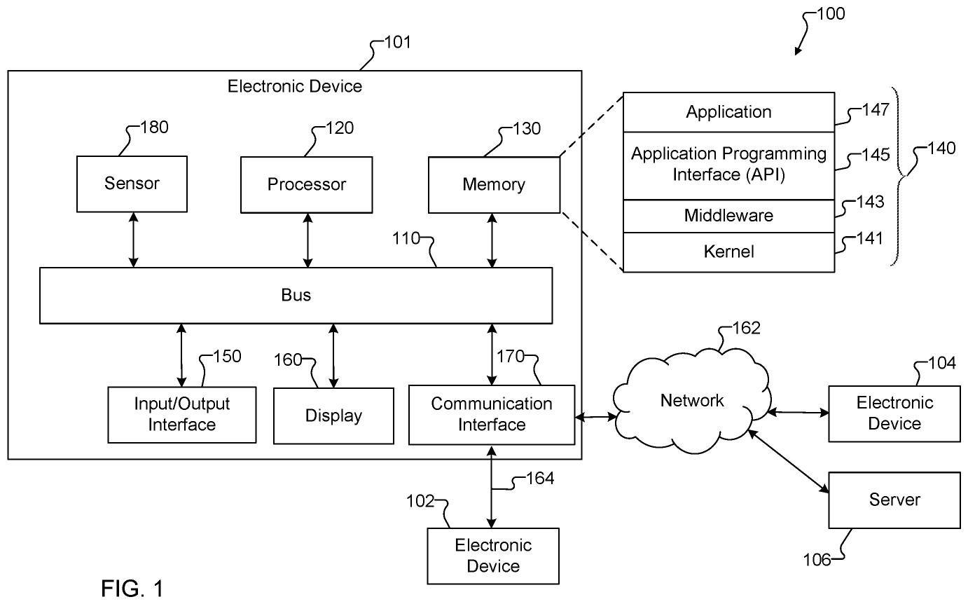

FIGS. 1 through 11, discussed below, and the various embodiments of this disclosure are described with reference to the accompanying drawings. However, it should be appreciated that this disclosure is not limited to these embodiments and all changes and/or equivalents or replacements thereto also belong to the scope of this disclosure.

As noted above, extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

Optical see-through (OST) XR systems refer to XR systems (including OST ME systems) in which users directly view real-world scenes through head-mounted devices (HMDs). Unfortunately, OST XR systems face many challenges that can limit their adoption. Some of these challenges include limited fields of view, limited usage spaces (such as indoor-only usage), failure to display fully-opaque black objects, and usage of complicated optical pipelines that may require projectors, waveguides, and other optical elements. In contrast to OST XR systems, video see-through (VST) XR systems (also called “passthrough” XR systems) present users with generated video sequences of real-world scenes. VST XR systems can be built using virtual reality (VR) technologies and can have various advantages over OST XR systems. For example, VST XR systems can provide wider fields of view and can provide improved contextual augmented reality.

A VST XR device often includes one or more imaging sensors (also called “see-through cameras”) that capture high-resolution image frames of a user's surrounding environment. These image frames are processed in an image processing pipeline in order to generate final rendered views of the user's surrounding environment. Visual quality of final view frames directly affects a user's experiences with the VST XR device. The visual quality of the final view frames often depends on the visual quality of the captured image frames.

VST MR systems obtain high-resolution color frames, combine the captured frame images with virtual objects generated by graphics, and render the images to the display panels after passthrough transformations. The user can see the enhanced images on the display panels through display lenses.

Video see-through AR captures scene videos with high-resolution see-through color cameras and combines the high-resolution color videos with virtual objects generated by computer graphics. The combined video is rendered, for example, to the display panels on head-mounted display (HMD) headset devices. The user sees the final images of enhanced screen.

As described above, in an HMD, the see-through camera(s) (or other imaging sensor) is separated from the user's eye(s), and both the camera lens and HMR display lens have static distortions. These static distortions can be corrected with camera and display calibration. In use, however, the user's head positioning and eye positioning will change, resulting in changes to the interpupillary distance (IPD), which is the distance between the user's pupils. The user's eye relief, the distance between the pupil of the eye and the display lens, also changes. Changes in IPD and eye relief causes changes to the user view and affects the user's perceived view frame image.

Disclosed embodiments include processes to dynamically compensate for the changes in eye positioning, by creating new mappings from the captured see-through frame to the eye view frame rendered on the display panels.

When the user looks at different objects with eye movements, the eyeball positions and orientations change, which makes the user's IPD and eye relief change. Disclosed embodiments adaptively create new mappings to generate new frames by considering the eye position and orientation changes to let the user perceive correct view images. This provides a distinct technical advantage in accuracy of reproduction and display, and provides improved user experiences for the VST HMD devices.

This disclosure provides various techniques related to final view mapping and distortion correction in video see-through mixed reality (MR) or other applications. As described in more detail below, disclosed embodiments include processes for final view mapping and distortion correction with eye pose changes for video see-through mixed reality or other applications.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to final view mapping and distortion correction in video see-through mixed reality (MR) or other applications.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform final view mapping and distortion correction in video see-through mixed reality (MR) or other applications. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include one or more cameras or other imaging sensors, which may be used to capture images of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit (IMU) that can include one or more accelerometers, gyroscopes, and other components, which can capture, for example, motion information and head pose information. The sensor(s) 180 can also include one or more eye tracking sensors that track a user's eye position, movement, and/or focus, which can be implemented using imaging sensors. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to final view mapping and distortion correction in video see-through mixed reality (MR) or other applications.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

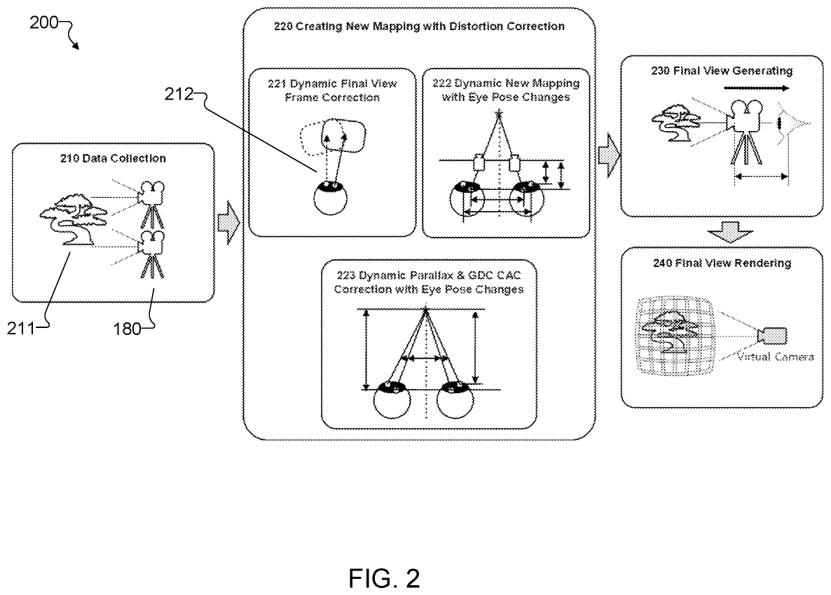

FIG. 2 illustrates an example high-level process 200 for final view mapping and distortion correction for video see-through MR or other applications in accordance with this disclosure. For ease of explanation, the process 200 of FIG. 2 is described as being implemented using the electronic device 101 in the network configuration 100 of FIG. 1. However, the process 200 may be implemented using any other suitable device(s) (such as the server 106) and in any other suitable system(s). The high-level processes described in the context of FIG. 2 can include any number of other processes and subprocesses, including those described with respect to other figures herein.

The high-level process illustrated in FIG. 2 allows the electronic device, among other things, to create new mappings for generating final view frames by considering eye movements while the user looks at different locations for video see-through MR.

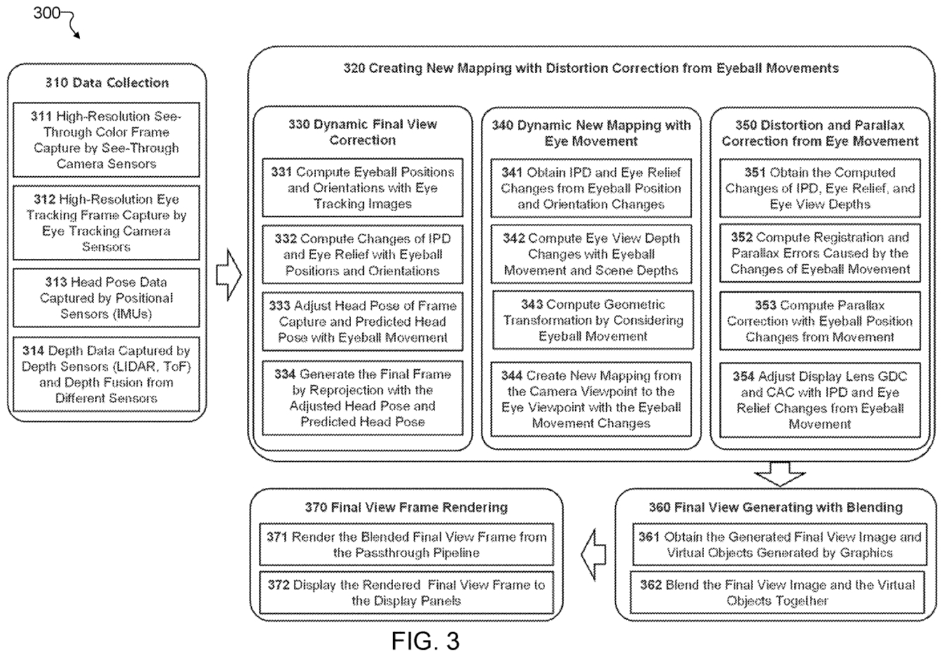

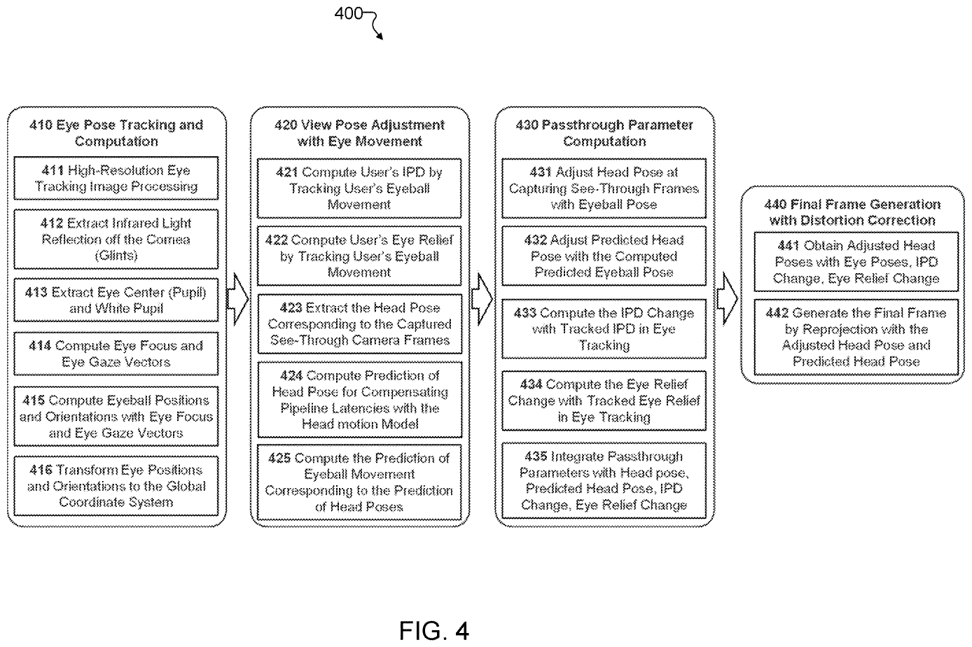

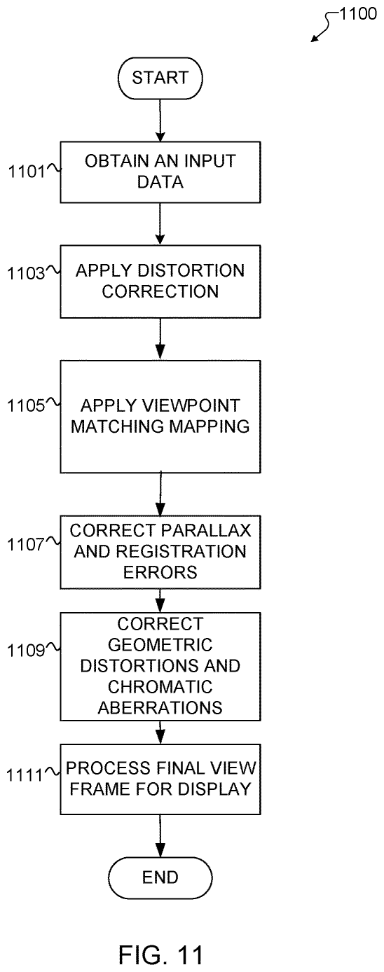

The electronic device can obtain input data at step 210. The input data can include image data of a scene 211, such as high-resolution see-through color frames, eye tracking data, and head pose data. The input data can be obtained, for example, by collecting the input data from sensors 180 such as depth sensors, eye tracking sensors, and image sensors such as cameras. This step corresponds to the data collection at step 310 in FIG. 3, eye pose tracking at step 410 in FIG. 4, and step 1101 in FIG. 11.

The electronic device can create new mapping for generating the final view frames by considering the user's eye movements at step 220. This step corresponds to the process of creating new mapping with distortion correction from eyeball movements at step 320 in FIG. 3.

As part of creating the new mapping at step 220, the electronic device can dynamically make distortion correction for the finally view frames by adaptively considering the eyeball movement while the user looks at different locations at step 221, as can be determined, for example, from eye tracking data 212 in the input data. This step can correspond, in some cases, to the dynamic final view correction at step 330 in FIG. 3, the view pose adjustment with eye movement at step 420 in FIG. 4, and step 1103 in FIG. 11.

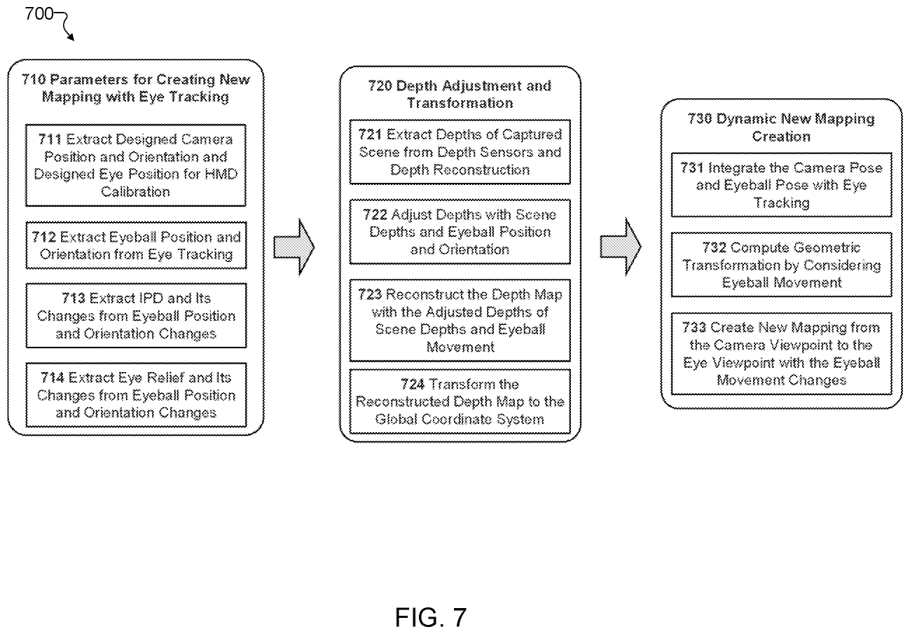

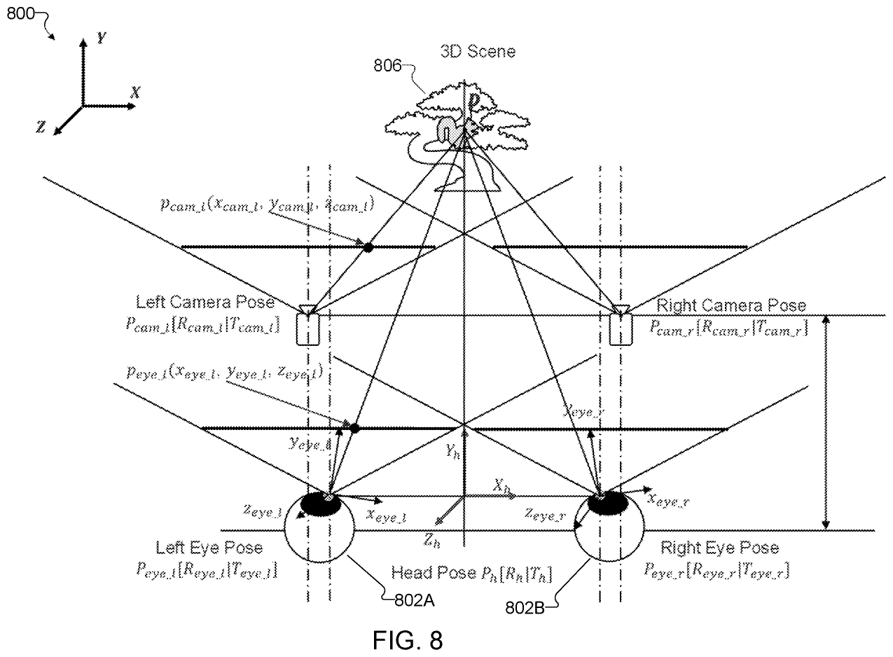

As part of creating the new mapping at step 220, the electronic device can create a new mapping from the see-through camera viewpoint to the eye viewpoint at step 222, for creating the final view frame, by considering the eye pose changes, such as eyeball movement that changes the IPD and eye relief for the eyes. This step can correspond, in some cases, to the dynamic new mapping creation at step 340 in FIG. 3, the process 700 for mapping in FIG. 7, the mapping equations in FIG. 8, and step 1105 in FIG. 11.

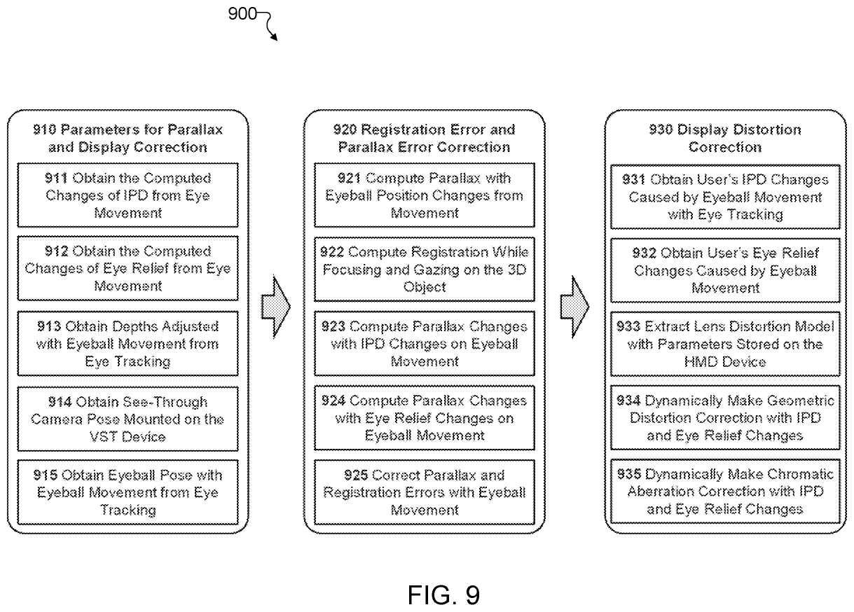

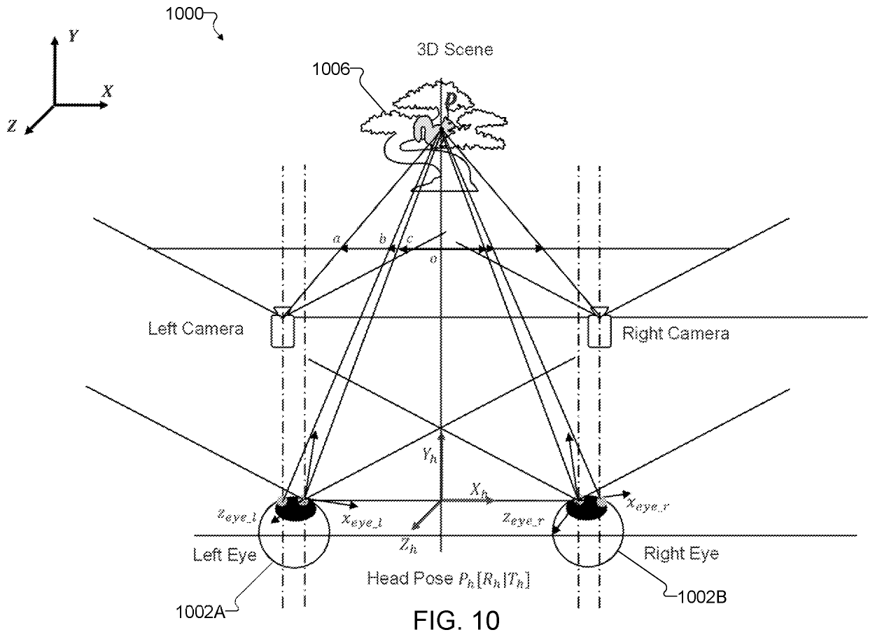

As part of creating the new mapping at step 220, the electronic device can dynamically correct parallax and registration errors with the user's eyeball movements and make corrections of display lens geometric distortions and chromatic aberrations with IPD and eye relief changes of the eye movements at step 223. This step can correspond, in some cases, to the distortion and parallax correction at step 350 in FIG. 3, the process 900 in FIG. 9, the parallax correction illustrated in FIG. 10, and steps 1107 and 1109 in FIG. 11.

After distortion correction at step 220, the electronic device can generate the final view frames by blending the final view frames with virtual objects generated by graphics at step 230. This step can correspond, in some cases, to the final view generating with blending at step 360 in FIG. 3 and the blending described in step 1103 of FIG. 11.

The electronic device can render the generated final view frames and display them (or process them for display) on display panels at step 240. This step can correspond, in some cases, to the final view frame rendering at step 370 in FIG. 3, the final frame generation at step 440 in FIG. 4, and step 1111 in FIG. 11.

The process of FIG. 2 can provide significant technical advantages when implemented in a head-mounted device. By dynamically creating new mappings that account for eye movements while the user looks at different locations, the HMD can generate final view frames that accurately reflect the user's actual visual perspective rather than a static camera-based view. This adaptive approach reduces visual discomfort and motion sickness that can occur when displayed images do not match the user's expected view, thereby improving the overall user experience and enabling longer comfortable usage sessions with video see-through mixed reality applications.

Although FIG. 2 illustrates one example of a high-level process 200 for final view mapping and distortion correction for video see-through MR or other applications, various changes may be made to FIG. 2. For example, various operations or functions in FIG. 2 may be combined, further subdivided, replicated, omitted, or rearranged and additional operations or functions may be added according to particular needs. Also, different portions of the process 200 could be performed using different devices, such as when one or more operations are performed by a first electronic device (like an HMD) and one or more other operations is performed offline by a second electronic device, for example to determine or configure camera parameters or to perform camera color calibration, or before the first electronic device is deployed.

FIG. 3 illustrates a more detailed process 300 for final view mapping with eye pose changes for video see-through MR or other applications in accordance with this disclosure. For ease of explanation, the process 300 of FIG. 3 is described as being implemented using the electronic device 101 in the network configuration 100 of FIG. 1. However, the process 300 may be implemented using any other suitable device(s) (such as the server 106) and in any other suitable system(s). The high-level processes described in the context of FIG. 3 can include any number of other processes and subprocesses, including those described with respect to other figures herein.

The process 300 includes primary actions of data collection at step 310, creating new mapping with distortion correction from eyeball movements at step 320, final view generating with blending virtual objects at step 360, and final view frame rendering at step 370. Each of these primary actions can be implemented using a series of substeps that explain, in detail, one way to accomplish the respective primary action.

As part of data collection at step 310, the electronic device can capture high-resolution see-through color frames at step 311, such as by using see-through camera sensors. This step can correspond, in some cases, to the input data collection at step 210 in FIG. 2 and step 1101 in FIG. 11.

The electronic device can capture high-resolution eye tracking frames, at step 312, such as by using eye tracking camera sensors. This step can correspond, in some cases, to the eye pose tracking and computing at step 410 in FIG. 4.

The electronic device can extract head pose data at step 313, such as by using positional sensors or inertial motion units (IMUs). This step can correspond, in some cases, to the head pose extraction at step 423 in FIG. 4.

The electronic device can capture and reconstruct depth data at step 314. This can be accomplished, for example, by using depth sensors such as LIDAR or Time-of-Flight (ToF) depth sensors. This step can correspond, in some cases, to the depth extraction at step 721 in FIG. 7.

The data collected from these processes of step 310 functions as the input data for the remaining steps, such as may be used in a video see-through MR pipeline.

The process of creating new mapping with distortion correction from eyeball movements at step 320 can include dynamic final view correction at step 330. This step can correspond, in some cases, to the distortion correction at step 221 in FIG. 2 and step 1103 in FIG. 11.

In the process of dynamic final view correction at step 330, the electronic device can compute eyeball positions and orientations with eye tracking images at step 331. This step can correspond, in some cases, to step 415 in FIG. 4.

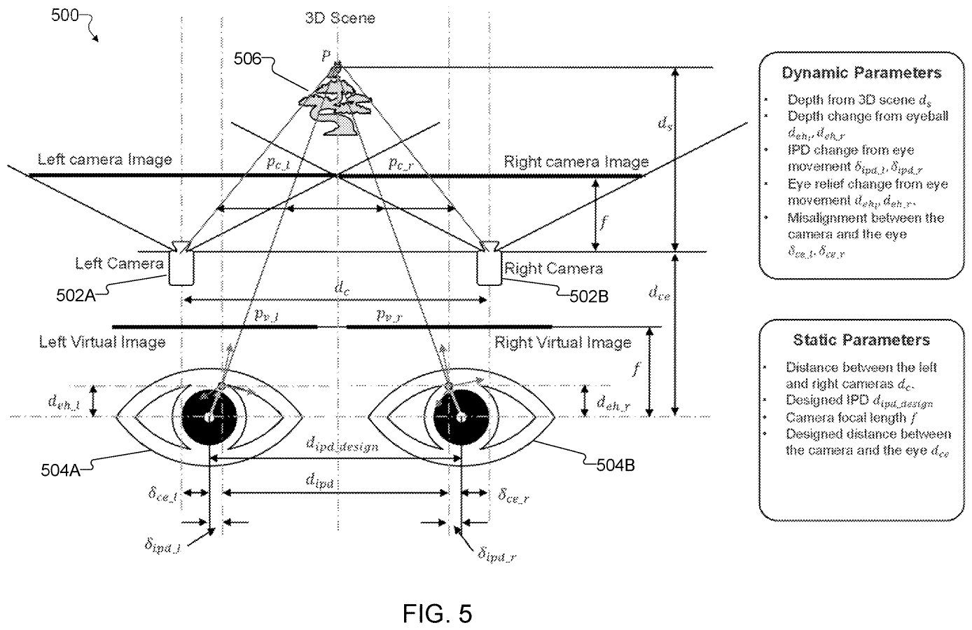

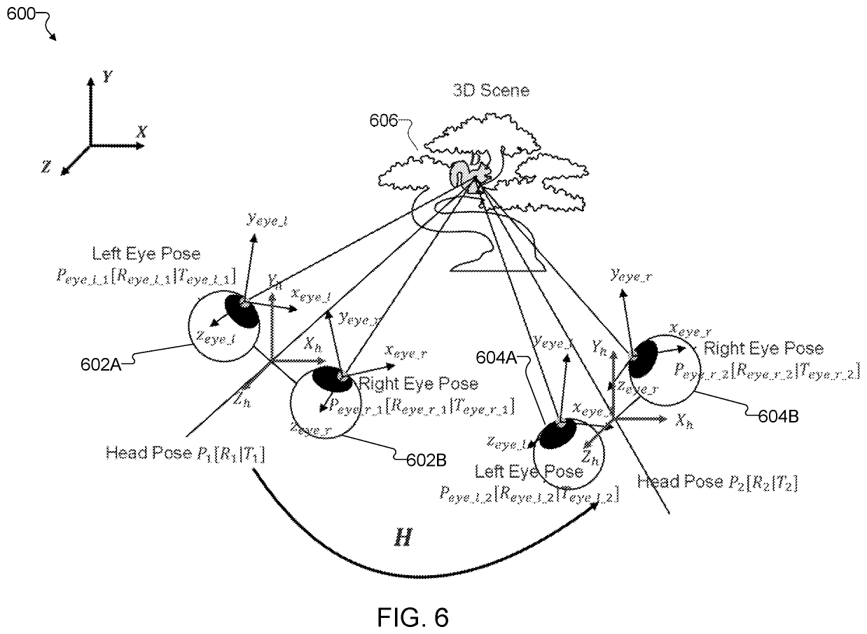

As part of dynamic final view correction at step 330, the electronic device can compute the changes of IPD and eye relief with eyeball positions and orientations at step 332. This step can correspond, in some cases, to steps 421-422 in FIG. 4, the IPD and eye relief calculations in FIG. 5, and the eye relief calculations in FIG. 6.

As part of dynamic final view correction at step 330, the electronic device can adjust the head pose of frame capture and predicted head pose with eyeball movements for reprojection of final view generation at step 333. This step can correspond, in some cases, to steps 423-425 in FIG. 4 and the head pose adjustment illustrated in FIG. 6.

As part of dynamic final view correction at step 330, the electronic device can generate the final view frame by reprojection with the adjusted head pose and the predicted head pose at step 334. In this way, the distortion of the generated final view frame is corrected by considering the eyeball movements. This step can correspond, in some cases, to step 442 in FIG. 4 and the reprojection equation in FIG. 6.

Creating the new mapping at step 320 can include dynamically creating a new mapping based on detected eye movement at step 340, which creates a new mapping between the camera “viewpoint” and the user's eye “viewpoint” to ensure accurate see-through reproduction with reduced or eliminated distortion. This step can correspond, in some cases, to step 222 in FIG. 2, the process 700 in FIG. 7, the mapping equations in FIG. 8, and step 1105 in FIG. 11.

In the process of dynamically creating new mapping from the see-through camera viewpoint to the eye viewpoint at step 340, the electronic device can obtain IPD and eye relief changes from eyeball position and orientation changes at step 341. This step can correspond, in some cases, to steps 713-714 in FIG. 7.

In the process of dynamically creating new mapping from the see-through camera viewpoint to the eye viewpoint at step 340, the electronic device can compute eye view depth changes with eyeball movement and scene depths at step 342. This step can correspond, in some cases, to steps 721-723 in FIG. 7.

In the process of dynamically creating new mapping from the see-through camera viewpoint to the eye viewpoint at step 340, the electronic device can compute geometric transformation by considering eyeball movement at step 343. This step can correspond, in some cases, to step 732 in FIG. 7.

In the process of dynamically creating new mapping from the see-through camera viewpoint to the eye viewpoint at step 340, the electronic device can create new mapping from the camera viewpoint to the eye viewpoint with eyeball movement changes at step 344. This step can correspond, in some cases, to step 733 in FIG. 7 and the mapping equations in FIG. 8.

Creating the new mapping at step 320 can include distortion and parallax correction from eye movement with eye tracking at step 350. This step can correspond, in some cases, to step 223 in FIG. 2, the process 900 in FIG. 9, the parallax correction in FIG. 10, and steps 1107-1109 in FIG. 11.

As part of the process of distortion and parallax correction from eye movement at step 350, the electronic device can obtain the computed changes of IPD, eye relief, and eye view depths at step 351. This step can correspond, in some cases, to steps 911-913 in FIG. 9.

As part of the process of distortion and parallax correction from eye movement at step 350, the electronic device can compute registration and parallax errors caused by the changes of eyeball movement at step 352. This step can correspond, in some cases, to steps 921-924 in FIG. 9 and the parallax computation in FIG. 10.

As part of the process of distortion and parallax correction from eye movement at step 350, the electronic device can compute parallax correction with eyeball position changes from eyeball movement at step 353. This step can correspond, in some cases, to step 925 in FIG. 9 and the parallax correction in FIG. 10.

As part of the process of distortion and parallax correction from eye movement at step 350, the electronic device can adjust display lens geometric distortion correction and chromatic aberration correction with IPD and eye relief changes from eyeball movement at step 354. This step can correspond, in some cases, to steps 934-935 in FIG. 9 and step 1109 in FIG. 11.

As part of the process of final view generating with blending at step 360, the electronic device can obtain the generated final view image from the passthrough pipeline and virtual objects generated by graphics at step 361. This step can correspond, in some cases, to step 230 in FIG. 2.

As part of the process of final view generating with blending at step 360, the electronic device can blend the final view image and the virtual object together at step 362. This step can correspond, in some cases, to step 230 in FIG. 2 and the blending described in FIG. 11.

As part of the process of final view frame rendering at step 370, the electronic device can render the blended frame from the passthrough pipeline at step 371. This step can correspond, in some cases, to step 240 in FIG. 2 and step 1111 in FIG. 11.

As part of the process of final view frame rendering at step 370, the electronic device can display the rendered final frame to the display panels at step 372. This step can correspond, in some cases, to step 240 in FIG. 2 and step 1111 in FIG. 11.

The process of FIG. 3 can provide significant technical advantages when implemented in a head-mounted device. By combining comprehensive data collection from multiple sensor types with dynamic final view correction, new mapping creation, and distortion correction based on eyeball movements, the HMD can produce high-quality final view frames that accurately represent the user's intended visual perspective. The integration of see-through camera data, eye tracking data, head pose data, and depth data enables precise compensation for the physical separation between the see-through cameras and the user's eyes, resulting in improved visual fidelity and reduced perceptual errors in video see-through mixed reality applications.

Although FIG. 3 illustrates one example of a more detailed process 300 for final view mapping with eye pose changes for video see-through MR, various changes may be made to FIG. 3. For example, various operations or functions in FIG. 3 may be combined, further subdivided, replicated, omitted, or rearranged and additional operations or functions may be added according to particular needs. Also, different portions of the process 300 could be performed using different devices, such as when one or more operations are performed by a first electronic device (like an HMD) and one or more other operations is performed offline by a second electronic device, for example to determine or configure camera parameters or to perform camera color calibration, or before the first electronic device is deployed.

FIG. 4 illustrates a more detailed process 400 for dynamic final view correction with eye tracking for video see-through MR or other applications in accordance with this disclosure. For ease of explanation, the process 400 of FIG. 4 is described as being implemented using the electronic device 101 in the network configuration 100 of FIG. 1. However, the process 400 may be implemented using any other suitable device(s) (such as the server 106) and in any other suitable system(s). The processes described in the context of FIG. 4 can include any number of other processes and subprocesses, including those described with respect to other figures herein.

The process 400 includes primary actions of eye pose tracking and computing at step 410, view pose adjustment with eye movement at step 420, passthrough parameter computation at step 430, and final frame generation with distortion correction at step 440. Each of these primary actions may be implemented by a number of subprocess that describe one way in which the primary action can be performed. Further, other processes and figures may be used to describe how specific processes are performed.

Eye pose tracking and computing at step 410 can be accomplished using the specific steps below, and as further explained with respect to FIG. 5, below. As part of eye pose tracking and computation at step 410, the electronic device can process the captured high-resolution eye tracking images at step 411. This step can use, for example, the eye tracking frames captured at step 312 in FIG. 3.

As part of eye pose tracking and computation at step 410, the electronic device can extract infrared light reflection off the cornea (glints) at step 412. This step can correspond, in some cases, to the eyeball position and orientation computation described in FIG. 5.

As part of eye pose tracking and computation at step 410, the electronic device can identify the pupil center and white pupil at step 413. This step can correspond, in some cases, to the IPD and eye relief calculations using pupil center positions in FIG. 5.

As part of eye pose tracking and computation at step 410, the electronic device can compute eye focus and eye gaze vectors at step 414. This step can correspond, in some cases, to the eye pose determination in FIG. 6.

As part of eye pose tracking and computation at step 410, the electronic device can compute eyeball positions and orientations with eye focus and eye gaze vectors at step 415. This step can correspond, in some cases, to step 331 in FIG. 3 and supports the eye pose calculations in FIG. 6.

As part of eye pose tracking and computation at step 410, the electronic device can transform the eye positions and orientations to the global coordinate system at step 416. This step can correspond, in some cases, to step 724 in FIG. 7.

View pose adjustment with eye movement at step 420 can be accomplished using the specific steps below, and as further explained with respect to FIG. 6, below.

As part of view pose adjustment with eye movement at step 420, the electronic device can compute user's IPD at step 421. This step can correspond, in some cases, to step 332 in FIG. 3, the IPD calculations in FIG. 5, and the IPD computation in FIG. 6.

As part of view pose adjustment with eye movement at step 420, the electronic device can compute the eye relief (for one or both eyes) at step 422 by tracking user's eyeball movement. This step can correspond, in some cases, to step 332 in FIG. 3, the eye relief calculations in FIG. 5, and the eye relief computation in FIG. 6.

As part of view pose adjustment with eye movement at step 420, the electronic device can extract the head pose corresponding to the captured see-through camera frames at step 423. This step can correspond, in some cases, to step 313 in FIG. 3 and supports the head pose adjustment in FIG. 6.

As part of view pose adjustment with eye movement at step 420, the electronic device can compute prediction of head pose for compensating pipeline latencies with the head motion model at step 424. This step can correspond, in some cases, to step 333 in FIG. 3 and supports the predicted head pose transformation in FIG. 6.

As part of view pose adjustment with eye movement at step 420, the electronic device can compute prediction of eyeball movement corresponding to the prediction of head pose at step 425. This step can correspond, in some cases, to step 333 in FIG. 3.

As part of passthrough parameter computation at step 430, the electronic device can adjust head pose at capturing see-through frames with eyeball pose at step 431, as described below with respect to FIG. 6. This step can correspond, in some cases, to step 333 in FIG. 3.

As part of passthrough parameter computation at step 430, the electronic device can adjust predicted head pose with computed predicted eyeball pose at step 432. This step can correspond, in some cases, to step 333 in FIG. 3 and the predicted head pose adjustment in FIG. 6.

As part of passthrough parameter computation at step 430, the electronic device can compute IPD change with tracked IPD in eye tracking at step 433. This step can correspond, in some cases, to steps 332 and 341 in FIG. 3, the IPD change calculations in FIG. 5, and step 713 in FIG. 7.

As part of passthrough parameter computation at step 430, the electronic device can compute eye relief change with tracked eye relief in eye tracking at step 434. This step can correspond, in some cases, to steps 332 and 341 in FIG. 3, the eye relief change calculations in FIG. 5, and step 714 in FIG. 7.

As part of passthrough parameter computation at step 430, the electronic device can integrate passthrough parameters with head pose adjusted with eye poses, predicted head pose adjusted with eye poses, IPD change, and eye relief change at step 435. This step can correspond, in some cases, to the parameter integration described in FIG. 6.

As part of final frame generation with distortion correction at step 440, the electronic device can obtain adjusted head poses with eye poses, IPD change, eye relief change at step 441. This step can correspond, in some cases, to step 334 in FIG. 3 and the adjusted head pose parameters in FIG. 6.

As part of final frame generation with distortion correction at step 440, the electronic device can generate the final frame by reprojecting the see-through frame with adjusted head pose and predicted head pose at step 442. This step can correspond, in some cases, to step 334 in FIG. 3, the reprojection equation in FIG. 6, and step 1111 in FIG. 11.

The process 400 of FIG. 4 provides significant technical advantages when implemented in a head-mounted device. By tracking eye poses in real-time and computing corresponding adjustments to IPD, eye relief, and head pose predictions, the HMD can dynamically compensate for pipeline latencies and generate final frames that match the user's actual eye positions at the time of display. This predictive approach reduces temporal mismatches between captured images and displayed frames, minimizing visual artifacts and improving the perceived stability and accuracy of the video see-through mixed reality experience.

Although FIG. 4 illustrates one example of a more detailed process 400 for dynamic final view correction with eye tracking for video see-through MR, various changes may be made to FIG. 4. For example, various operations or functions in FIG. 4 may be combined, further subdivided, replicated, omitted, or rearranged and additional operations or functions may be added according to particular needs. Also, different portions of the process 300 could be performed using different devices, such as when one or more operations are performed by a first electronic device (like an HMD) and one or more other operations is performed offline by a second electronic device, for example to determine or configure camera parameters or to perform camera color calibration, or before the first electronic device is deployed.

FIG. 5 illustrates a diagram 500 of parameters for a passthrough pipeline with eye movement tracking in accordance with this disclosure. For ease of explanation, diagram 500 illustrates various parameters including measurements that can be used, in some implementations, to perform eye tracking and final image correction as described herein. However, the diagram 500 and its specific measurements, variables, and other factors are not required in every implementation of the processes described herein.

While the see-through cameras (shown in FIG. 5 as 502A and 502B) and eyes (shown in FIG. 5 as 504A and 504B) are looking at the point P of 3D scene 506, the electronic device can obtain correspondence points (p_{c_l}, p_{v_l}) on the left camera image and left virtual image and correspondence points (p_{c_r}, p_{v_r}) on the right camera image and right virtual image. Let d_{ipd_design} represent the designed IPD. The electronic device can compute the current user's IPD with the positions of the left and right pupil centers and compute the changes of the IPD on the left eye δ_{ipd_l} and on the right eye δ_{ipd_r}, for example using:

$$\{ \begin{matrix}{δ}_{ipd \_ l} = \frac{{d}_{ipd \_ design} - {d}_{ipd}}{2} \\ {δ}_{ipd \_ r} = \frac{{d}_{ipd \_ design} - {d}_{ipd}}{2}\end{matrix}$$

The electronic device can also compute eye relief changes on the left eye d_{eh_l} and on the right eye d_{eh_r} with the positions of the pupil centers.

Using the positions of cameras and the designed eye centers, the electronic device can compute the differences, for example using:

$$\{ \begin{matrix}{δ}_{ce \_ l} = \frac{{d}_{c} - {d}_{ipd \_ design}}{2} \\ {δ}_{ce \_ 2} = \frac{{d}_{c} - {d}_{ipd \_ design}}{2}\end{matrix}$$

These calculations are usable, for example, as part of view pose adjustment with eye movement at step 420 and passthrough parameter computation at step 430.

The parameters and calculations illustrated in FIG. 5 provide significant technical advantages when implemented in a head-mounted device. By precisely computing IPD changes and eye relief changes using tracked pupil center positions and camera positions, the HMD can accurately model the geometric relationship between the see-through cameras and the user's actual eye positions. This mathematical framework enables the device to adapt to individual user differences and real-time eye movements, resulting in more accurate passthrough transformations and improved visual comfort across a wide range of users and viewing conditions.

FIG. 6 illustrates a diagram 600 of head pose and eyeball poses with eye movement for use in final view frame generation. For ease of explanation, diagram 600 illustrates various parameters including measurements that can be used, in some implementations, to perform final image correction using head pose and eyeball poses with eye movement as described herein. However, the diagram 600 and its specific measurements, variables, and other factors are not required in every implementation of the processes described herein.

As illustrated in FIG. 6, a user's eyes are illustrated in a first position/pose as left eye 602A and right eye 602B, and the same eyes in a second position/pose as left eye 604A and right eye 604B. These are shown in relation to a 3D scene 606.

In head pose P₂[R₂|T₂], consider the left eye pose and the right eye pose, for example as:

$$\{ \begin{matrix}{P}_{eye \_ l \_ 2} [ {R}_{eye \_ l \_ 2} \vert {T}_{eye \_ l \_ 2} ] \\ {P}_{eye \_ r \_ 2} [ {R}_{eye \_ r \_ 2} \vert {T}_{eye \_ r \_ 2} ]\end{matrix}$$

The electronic device can compute the current user's IPD as, for example,

$${d}_{ipd \_ 2} = \sqrt{{( {x}_{eye \_ l \_ 2} - {x}_{eye \_ r \_ 2} )}^{2} + {( {y}_{eye \_ l \_ 2} - {y}_{eye \_ r \_ 2} )}^{2} + {( {z}_{eye \_ l \_ 2} - {z}_{eye \_ r \_ 2} )}^{2}}$$

With the eyeball movement tracking, the electronic device can also compute eye relief for head poses P₁[R₁|T₁], P₂[R₂|T₂], for example as:

$$\{ \begin{matrix}{d}_{eye \_ l} = f ( {P}_{eye \_ l \_ 1} [ {R}_{eye \_ l \_ 1} \vert {T}_{eye \_ l \_ 1} ] , {P}_{eye \_ r \_ 1} [ {R}_{eye \_ r \_ 1} \vert {T}_{eye \_ r \_ 1} ] , {d}_{s} , {d}_{ce} ) \\ {d}_{eye \_ r} = f ( {P}_{eye \_ l \_ 2} [ {R}_{eye \_ l \_ 2} \vert {T}_{eye \_ l \_ 2} ] , {P}_{eye \_ r \_ 2} [ {R}_{eye \_ r \_ 2} \vert {T}_{eye \_ r \_ 2} ] , {d}_{s} , {d}_{ce} )\end{matrix}$$

As shown in FIG. 6, the electronic device can transform the frame from head pose P₁[R₁|T₁] to head pose P₂[R₂|T₂] using transformation H.

In this example, in the process of passthrough parameter computation at step 430, the electronic device can adjust head pose at capturing see-through frames with eyeball pose at step 431, for example using:

$$\{ \begin{matrix}{P}_{1} [ {R}_{1} \vert {T}_{1} ] ← ℱ [ {P}_{1} [ {R}_{1} \vert {T}_{1} ] , {P}_{eye \_ l \_ 1} [ {R}_{eye \_ l \_ 1} \vert {T}_{eye \_ l \_ 1} ] , {P}_{eye \_ r \_ 1} [ {R}_{eye \_ r \_ 1} \vert {T}_{eye \_ r \_ 1} ] ] \\ {P}_{2} [ {R}_{2} \vert {T}_{2} ] ← ℱ [ {P}_{2} [ {R}_{2} \vert {T}_{2} ] , {P}_{eye \_ l \_ 2} [ {R}_{eye \_ l \_ 2} \vert {T}_{eye \_ l \_ 2} ] , {P}_{eye \_ r \_ 2} [ {R}_{eye \_ r \_ 2} \vert {T}_{eye \_ r \_ 2} ] ]\end{matrix}$$

The same or a similar technique can be used in the process of passthrough parameter computation at step 430, for example for computing IPD change and eye relief change, and integrating those passthrough parameters with head pose adjusted with eye poses, predicted head pose adjusted with eye poses, IPD change, and eye relief change.

FIG. 6 can also be used to illustrate the process of final frame generation with distortion correction at step 440. In this example, the electronic device obtains adjusted head poses with eye poses, IPD change, eye relief change at step 441 and generates the final frame by reprojecting the see-through frame with adjusted head pose and predicted head pose at step 442, for example using:

Iₒᵤₜ(x,y)=H(P₁[R₁|T₁],P₂[R₂|T₂],parameters)*lᵢₙ(x,y)

where H is the passthrough transformation matrix and lᵢₙ(x, y) is the input frame image.

The head pose and eyeball pose calculations illustrated in FIG. 6 provide significant technical advantages when implemented in a head-mounted device. By mathematically modeling the relationships between head poses, eye poses, and the transformations needed for reprojection, the HMD can efficiently compute adjusted head poses that account for eyeball movement. This enables the device to generate accurate final view frames through a single integrated transformation, reducing computational overhead while maintaining high visual quality and proper alignment between the displayed content and the user's visual perspective.

FIG. 7 illustrates a process 700 for mapping between the see-through frame to the final view frame in accordance with this disclosure. For ease of explanation, the process 700 of FIG. 7 is described as being implemented using the electronic device 101 in the network configuration 100 of FIG. 1. However, the process 700 may be implemented using any other suitable device(s) (such as the server 106) and in any other suitable system(s). The processes described in the context of FIG. 7 can include any number of other processes and subprocesses, including those described with respect to other figures herein.

The process 700 includes primary actions of determining parameters for creating new mapping with eye tracking at step 710, performing depth adjustment and transformation at step 720, and dynamic new mapping creation at step 730. Each of these primary actions may be implemented by a number of subprocess that describe one way in which the primary action can be performed. Further, other processes and figures may be used to describe how specific processes are performed.

As part of the process of determining parameters for new mapping with eye tracking at step 710, the electronic device can extract designed camera position and orientation and designed eye position and HMD calibration at step 711. This step can support the camera and eye pose integration at step 731.

As part of the process of determining parameters for new mapping with eye tracking at step 710, the electronic device can extract eyeball position and orientation from eye tracking at step 712. This step can correspond, in some cases, to steps 331 and 415 in FIGS. 3 and 4, respectively.

As part of the process of determining parameters for new mapping with eye tracking at step 710, the electronic device can extract IPD and its changes from eyeball position and orientation changes at step 713. In the process of determining parameters for new mapping with eye tracking at step 710, the electronic device can extract eye relief and its changes from eyeball position and orientation changes at step 714. These steps can correspond, in some cases, to steps 332 and 341 in FIG. 3, steps 421-422 and 433-434 in FIG. 4, and the IPD and eye relief calculations in FIGS. 5 and 6.

As part of the process of performing depth adjustment and transformation at step 720, the electronic device can extract depths of captured scene from depth sensors and depth reconstruction at step 721. This step can correspond, in some cases, to step 314 in FIG. 3.

As part of the process of performing depth adjustment and transformation at step 720, the electronic device can adjust depths with scene depths and eyeball position and orientation at step 722. This step can correspond, in some cases, to step 342 in FIG. 3.

As part of the process of performing depth adjustment and transformation at step 720, the electronic device can reconstruct the depth map with adjusted depths of the scene depths and eyeball movement at step 723. This step can correspond, in some cases, to step 342 in FIG. 3.

As part of the process of performing depth adjustment and transformation at step 720, the electronic device can transform the reconstructed depth map to the global coordinate system at step 724. This step can correspond, in some cases, to step 416 in FIG. 4.

As part of the process of dynamic new mapping creation at step 730, the electronic device can integrate the camera pose and eyeball pose with eye tracking at step 731. This step can support the mapping creation described in FIG. 8.

As part of the process of dynamic new mapping creation at step 730, the electronic device can compute geometric transformation by considering eyeball movement at step 732. This step can correspond, in some cases, to step 343 in FIG. 3 and can support the mapping equations in FIG. 8.

As part of the process of dynamic new mapping creation at step 730, the electronic device can create new mapping from the camera viewpoint to the eye viewpoint with the eyeball movement changes at step 733. This step can correspond, in some cases, to step 344 in FIG. 3, the mapping equations in FIG. 8, and step 1105 in FIG. 11.

The process 700 of FIG. 7 provides significant technical advantages when implemented in a head-mounted device. By systematically determining mapping parameters from eye tracking data, performing depth adjustments based on scene geometry and eyeball positions, and dynamically creating new viewpoint mappings, the HMD can accurately transform captured see-through frames to match the user's eye viewpoint. This comprehensive mapping approach accounts for both the static geometric differences between camera and eye positions and the dynamic changes caused by eye movements, resulting in more natural and accurate visual reproduction of the user's environment.

Although FIG. 7 illustrates one example of a process 700 for mapping between the see-through frame to the final view frame, various changes may be made to FIG. 7. For example, various operations or functions in FIG. 7 may be combined, further subdivided, replicated, omitted, or rearranged and additional operations or functions may be added according to particular needs. Also, different portions of the process 700 could be performed using different devices, such as when one or more operations are performed by a first electronic device (like an HMD) and one or more other operations is performed offline by a second electronic device, for example to determine or configure camera parameters or to perform camera color calibration, or before the first electronic device is deployed.

FIG. 8 illustrates a diagram 800 of creating a mapping between the see-through frame at see-through camera viewpoint to the user's eye viewpoint by considering eyeball movements in accordance with this disclosure.

Suppose P_{cam_l}[R_{cam_l}|T_{cam_l}] and P_{cam_r}[R_{cam_r}\T_{cam_l}] are the left camera pose and the right camera pose on the HMD device, P_{eye_l}[R_{eye_l}|T_{eye_l}] and P_{eye_r}[R_{eye_r}|T_{eye_l}] are the left eye pose and the right camera pose (of eyes 802A and 802B), and Pₕ[Rₕ|Tₕ] is the current head pose when viewing a scene 806.

The electronic device can create a mapping between the left see-through camera and the left eye by considering the eyeball movement, for example using:

$$( \begin{matrix}{x}_{eye \_ l} \\ {y}_{eye \_ l} \\ {z}_{eye \_ l} \\ {w}_{l}\end{matrix} ) = {P}_{eye \_ l} [ {R}_{eye \_ r \_ l} \vert {T}_{eye \_ 1} ] {P}_{cam \_ l}^{- 1} [ {R}_{cam \_ l} \vert {T}_{cam \_ l} ] ( \begin{matrix}{x}_{cam \_ l} \\ {y}_{cam \_ l} \\ {z}_{cam \_ l} \\ 1\end{matrix} )$$

Similarly, the electronic device can create a mapping between the right see-through camera and the right eye by considering the eyeball movement, for example using:

$$( \begin{matrix}{x}_{eye \_ r} \\ {y}_{eye \_ r} \\ {z}_{eye \_ r} \\ {w}_{r}\end{matrix} ) = {P}_{eye \_ r} [ {R}_{eye \_ r} \vert {T}_{eye \_ r} ] {P}_{cam \_ r}^{- 1} [ {R}_{cam \_ r} \vert {T}_{cam \_ r} ] ( \begin{matrix}{x}_{cam \_ r} \\ {y}_{cam \_ r} \\ {z}_{cam \_ r} \\ 1\end{matrix} )$$

The mapping equations illustrated in FIG. 8 provide significant technical advantages when implemented in a head-mounted device. By establishing mathematical relationships between the see-through camera viewpoints and the user's eye viewpoints while considering eyeball movements, the HMD can create accurate correspondence mappings for both left and right eyes independently. This binocular approach ensures that each eye receives properly transformed imagery that accounts for its specific position and orientation, enabling correct stereoscopic depth perception and reducing visual strain in video see-through mixed reality applications.

FIG. 9 illustrates a process 900 for performing dynamic parallax correction caused by eyeball movements in accordance with this disclosure. For ease of explanation, the process 900 of FIG. 9 is described as being implemented using the electronic device 101 in the network configuration 100 of FIG. 1. However, the process 900 may be implemented using any other suitable device(s) (such as the server 106) and in any other suitable system(s). The processes described in the context of FIG. 9 can include any number of other processes and subprocesses, including those described with respect to other figures herein.

The process 900 includes primary actions of extracting parameters for parallax and display correction at step 910, registration error and parallax error correction at step 920, and display distortion correction at step 930. Each of these primary actions may be implemented by a number of subprocess that describe one way in which the primary action can be performed. Further, other processes and figures may be used to describe how specific processes are performed.

As a part of the process of extracting parameters for parallax and display correction at step 910, the electronic device can obtain the computed changes of IPD from eye movement at step 911. This step can correspond, in some cases, to steps 332 and 351 in FIG. 3 and step 433 in FIG. 4.

As a part of the process of extracting parameters for parallax and display correction at step 910, the electronic device can obtain the computed changes of eye relief from eye movement at step 912. This step can correspond, in some cases, to steps 332 and 351 in FIG. 3 and step 434 in FIG. 4.

As a part of the process of extracting parameters for parallax and display correction at step 910, the electronic device can obtain the depths adjusted with eyeball movement from eye tracking at step 913. This step can correspond, in some cases, to steps 342 and 351 in FIG. 3 and steps 721-723 in FIG. 7.

As a part of the process of extracting parameters for parallax and display correction at step 910, the electronic device can obtain the see-through camera pose mounted on the VST device at step 914. This step can correspond, in some cases, to step 711 in FIG. 7.

As a part of the process of extracting parameters for parallax and display correction at step 910, the electronic device can obtain the eyeball pose with eyeball movement from eye tracking at step 915. This step can correspond, in some cases, to steps 331 and 415 in FIGS. 3 and 4, respectively, and step 712 in FIG. 7.

As a part of the process of registration error and parallax error correction at step 920, the electronic device can compute parallax with eyeball position changes from movement at step 921. This step can correspond, in some cases, to step 353 in FIG. 3.

As a part of the process of registration error and parallax error correction at step 920, the electronic device can compute registration while focusing and gazing on the 3D object at step 922. This step can correspond, in some cases, to step 352 in FIG. 3.

As a part of the process of registration error and parallax error correction at step 920, the electronic device can compute parallax changes with IPD changes on eyeball movement at step 923. This step can correspond, in some cases, to steps 352-353 in FIG. 3 and the parallax computation in FIG. 10.

As a part of the process of registration error and parallax error correction at step 920, the electronic device can compute parallax changes with eye relief changes on eyeball movement at step 924. This step can correspond, in some cases, to steps 352-353 in FIG. 3 and the parallax computation in FIG. 10.

As a part of the process of registration error and parallax error correction at step 920, the electronic device can correct parallax and registration errors with eyeball movement at step 925. This step can correspond, in some cases, to step 353 in FIG. 3, the parallax correction in FIG. 10, and step 1107 in FIG. 11.

As a part of the display distortion correction at step 930, the electronic device can obtain user's IPD changes caused by eyeball movement with eye tracking at step 931. This step can correspond, in some cases, to steps 332 and 351 in FIG. 3, step 433 in FIG. 4, and step 713 in FIG. 7.

As a part of the display distortion correction at step 930, the electronic device can obtain user's eye relief changes caused by eye relief changes caused by eyeball movement at step 932. This step can correspond, in some cases, to steps 332 and 351 in FIG. 3, step 434 in FIG. 4, and step 714 in FIG. 7.

As a part of the display distortion correction at step 930, the electronic device can extract display lens distortion model with parameters stored on the HMD device at step 933. This step can support the geometric distortion and chromatic aberration corrections at steps 934-935.

As a part of the display distortion correction at step 930, the electronic device can dynamically make geometric distortion correction with IPD and eye relief changes at step 934. This step can correspond, in some cases, to step 354 in FIG. 3 and step 1109 in FIG. 11.

As a part of the display distortion correction at step 930, the electronic device can make chromatic aberration correction with IPD and eye relief changes at step 935. This step can correspond, in some cases, to step 354 in FIG. 3 and step 1109 in FIG. 11.

The process of FIG. 9 provides significant technical advantages when implemented in a head-mounted device. By extracting parameters for parallax and display correction, computing and correcting registration and parallax errors, and dynamically adjusting for display lens geometric distortions and chromatic aberrations based on IPD and eye relief changes, the HMD can deliver visually accurate final view frames that account for both optical system characteristics and user-specific eye positioning. This multi-stage correction approach ensures that virtual objects appear correctly registered with the real-world scene and that color fidelity is maintained across the display, enhancing the realism and usability of video see-through mixed reality experiences.

Although FIG. 9 illustrates one example of a process 900 for performing dynamic parallax correction caused by eyeball movements, various changes may be made to FIG. 9. For example, various operations or functions in FIG. 9 may be combined, further subdivided, replicated, omitted, or rearranged and additional operations or functions may be added according to particular needs. Also, different portions of the process 900 could be performed using different devices, such as when one or more operations are performed by a first electronic device (like an HMD) and one or more other operations is performed offline by a second electronic device, for example to determine or configure camera parameters or to perform camera color calibration, or before the first electronic device is deployed.

FIG. 10 illustrates a diagram 1000 of dynamic parallax correction caused by eyeball movement. For ease of explanation, diagram 1000 illustrates various parameters including measurements that can be used, in some implementations, to perform dynamic parallax correction as described herein. However, the diagram 1000 and its specific measurements, variables, and other factors are not required in every implementation of the processes described herein.

FIG. 10 illustrates dynamic parallax correction caused by eyeball movement of eyes 1002A and 1002B with respect to a scene 1006.

The current head pose is Pₕ[Rₕ|Tₕ]. The cameras and eyes 1002A and 1002B look at the target D in the 3D scene 1006. The parallax of the left camera viewpoint is lₒₐ. If eyeball movement is not considered, the parallax of the left eye viewpoint is l_{ob}. While considering eyeball movement, the parallax of the left eye viewpoint is l_{oc}. The electronic device can compute the correct parallax with the tracked eyeball poses.

In some cases, the electronic device can compute eyeball poses with eye tracking to obtain IPD and eye relief changes and create the final view by dynamically adapting these changes.

In other cases, the electronic device can use the head pose as the eye pose and create the final view frame by passthrough transformation with the head poses.

Similarly, in some cases, the electronic device can create a mapping from the see-through camera frame to the eye view frame in the head pose while capturing the see-through frame and then transform the created eye view frame from the head pose to predicted final head pose with reprojection for head pose change compensation by considering eyeball movements. In other cases, these two transformations are combined together into one transformation. The electronic device can directly transform the see-through frame from the camera viewpoint in the head pose while capturing the camera frame to the eye view frame in the predicted final view head pose by considering eyeball movement with eye tracking.

The dynamic parallax correction illustrated in FIG. 10 provides significant technical advantages when implemented in a head-mounted device. By computing correct parallax values that account for tracked eyeball poses rather than assuming fixed eye positions, the HMD can accurately represent depth relationships in the displayed imagery as the user's eyes move. This adaptive parallax correction ensures that objects appear at their correct perceived distances regardless of eye position changes, reducing vergence-accommodation conflicts and improving the three-dimensional accuracy of video see-through mixed reality applications.

Note that the specific sequence of operations in the processes above may be adapted in different embodiments. For example, in some cases, the electronic device can first perform reprojection for head pose change compensation to generate the final view frames and then perform image enhancement to improve image quality.

Disclosed embodiments provide a number of technical improvements over other systems. For example, disclosed embodiments can efficiently and effectively generate the final view frames by dynamically considering changes of user's IPD, eye relief, and eyeball poses with eye tracking. The generated final view frames can fit the user's eye better with adaptive correcting the distortions and parallax changes.

As another example, disclosed embodiments can dynamically compute the user's IPD and track IPD changes in video see-through MR.

As another example, disclosed embodiments can automatically compute a user's IPD and track IPD changes with eye tracking, including computing the eyeball positions and orientations with eye tracking images. The eyeball positions and orientations can then be further used for computing the IPD and changes.

FIG. 11 illustrates an integrated process 1100 for final view mapping and distortion correction with eye pose changes for video see-through mixed reality or other applications in accordance with this disclosure. For ease of explanation, the process 1100 of FIG. 11 is described as being implemented using the electronic device 101 in the network configuration 100 of FIG. 1. However, the process 1100 may be implemented using any other suitable device(s) (such as the server 106) and in any other suitable system(s). The processes described in the context of FIG. 11 can include any number of other processes and subprocesses, including those described with respect to other figures herein.

The electronic device can obtain input data at step 1101. The input data can include, for example, image data of a scene, eye tracking data, and head pose data. For example, as described with respect to FIG. 2 at step 210, the input data can be obtained by collecting data from sensors such as depth sensors, eye tracking sensors, and image sensors such as cameras. FIG. 3, such as at steps 311-314, further describes data collection as including capturing high-resolution see-through color frames using see-through camera sensors (at step 311), capturing high-resolution eye tracking frames using eye tracking camera sensors (at step 312), extracting head pose data using positional sensors or inertial motion units (at step 313), and capturing and reconstructing depth data using depth sensors such as LIDAR or Time-of-Flight (ToF) sensors (at step 314). FIG. 4, for example at steps 411-416, describes processing eye tracking images to extract infrared light reflection off the cornea (glints), identify the pupil center and white pupil, compute eye focus and eye gaze vectors, and compute eyeball positions and orientations.

The electronic device can apply a distortion correction mapping to the image data based on the eye tracking data, at step 1103, to produce final view frames for display. As part of applying the distortion correction mapping, the electronic device can compute a change in interpupillary distance (IPD) and a change in eye relief corresponding to the eye tracking data. As part of applying the distortion correction mapping, the electronic device can predict a change between a first head pose when the image data is obtained and a second head pose when final view frames are processed for display. The prediction can be based in part on the change in IPD and the change in eye relief. As part of applying the distortion correction mapping, the electronic device can produce the final view frames based on the predicted change between the first head pose and the second head pose. As described, for example, with respect to FIG. 2 at step 221, the electronic device can dynamically make distortion correction for final view frames by adaptively considering eyeball movement while the user looks at different locations. FIG. 3, for example at steps 331-334, provides further detail on dynamic final view correction, including computing eyeball positions and orientations with eye tracking images at step 331, computing changes of IPD and eye relief with eyeball positions and orientations at step 332, adjusting head pose of frame capture and predicted head pose with eyeball movements for reprojection at step 333, and generating the final view frame by reprojection with the adjusted head pose and predicted head pose at step 334. FIG. 4, for example at steps 420-435, describes view pose adjustment with eye movement, including computing the user's IPD at step 421, computing eye relief by tracking user's eyeball movement at step 422, extracting head pose corresponding to captured see-through camera frames at step 423, computing prediction of head pose for compensating pipeline latencies at step 424, and computing prediction of eyeball movement corresponding to the prediction of head pose at step 425. FIG. 5 provides parameters and equations for computing IPD changes and eye relief changes with the positions of pupil centers. FIG. 6 illustrates head pose and eyeball poses with eye movement, including equations for adjusting head pose at capturing see-through frames with eyeball pose and generating the final frame by reprojecting the see-through frame.

In some cases, generating the final view frame can include generating virtual objects by the electronic device and blending the generated objects with the image data to produce the final view frame. For example, as described with respect to FIG. 2 at step 230, the electronic device can generate final view frames by blending with virtual objects generated by graphics. FIG. 3, for example at steps 361-362, further describes obtaining the generated final view image from the passthrough pipeline and virtual objects generated by graphics at step 361, and blending the final view image and the virtual object together at step 362.

The electronic device can apply a viewpoint matching mapping between viewpoints of image data and viewpoints of a user's eyes, at step 1105, based in part on the eye tracking data. In some cases, the input data also includes scene depth data, as part of applying the viewpoint matching mapping, the electronic device can compute a change in eye view depth based on the change in IPD, the change in eye relief, and the scene depth data. A part of applying the viewpoint matching mapping, the electronic device can generate the viewpoint matching mapping between the viewpoints image sensors of the electronic device (as in the image data) and viewpoints of the user's eyes based on the change in the eye view depth. As part of applying the viewpoint matching mapping, the electronic device can apply the viewpoint matching mapping to the image data to generate the final view frames. For example, as described with respect to FIG. 2 at step 222, the electronic device can create a new mapping from the see-through camera viewpoint to the eye viewpoint by considering eye pose changes such as eyeball movement that changes the IPD and eye relief. FIG. 3, for example at steps 341-344, describes dynamically creating a new mapping based on detected eye movement, including obtaining IPD and eye relief changes from eyeball position and orientation changes at step 341, computing eye view depth changes with eyeball movement and scene depths at step 342, computing geometric transformation by considering eyeball movement at step 343, and creating new mapping from the camera viewpoint to the eye viewpoint with eyeball movement changes at step 344. FIG. 7 describes a process for mapping between the see-through frame and the final view frame, including determining parameters for new mapping with eye tracking at steps 711-714, performing depth adjustment with scene depths and eyeball position and orientation at steps 721-724, and dynamic new mapping creation by integrating camera pose and eyeball pose at steps 731-733. FIG. 8 provides equations for creating a mapping between the see-through camera viewpoint and the user's eye viewpoint by considering eyeball movements.

The electronic device can correct parallax error and registration error in the final view frames, at step 1107, using the eye tracking data. In some cases, correcting the parallax error and the registration error is based on the change in IPD, the change in eye relief, and the change in the eye view depth. As described, for example, with respect to FIG. 2 at step 223, the electronic device can dynamically correct parallax and registration errors with the user's eyeball movements. FIG. 3, for example at steps 351-354 describes distortion and parallax correction from eye movement with eye tracking, including obtaining the computed changes of IPD, eye relief, and eye view depths at step 351, computing registration and parallax errors caused by the changes of eyeball movement at step 352, computing parallax correction with eyeball position changes from eyeball movement at step 353, and adjusting display lens geometric distortion correction and chromatic aberration correction with IPD and eye relief changes from eyeball movement at step 354. FIG. 9, for example at steps 920-925, provides further detail on registration error and parallax error correction, including computing registration while focusing and gazing on the 3D object at step 922, computing parallax changes with IPD changes on eyeball movement at step 923, computing parallax changes with eye relief changes on eyeball movement at step 924, and correcting parallax and registration errors with eyeball movement at step 925. FIG. 10 illustrates dynamic parallax correction caused by eyeball movement and demonstrates how the electronic device computes correct parallax with tracked eyeball poses by comparing parallax at the camera viewpoint and at the eye viewpoint while considering eyeball movement.

The electronic device can correct display lens geometric distortions and chromatic aberrations in the final view frames, at step 1109, using the eye tracking data. In some cases, correcting display lens geometric distortions and chromatic aberrations in the final view frames is based on a distortion model comprising stored parameters, and the distortion model is modified according to the change in IPD and the change in eye relief. As described, for example with respect to FIG. 2 at step 223, the electronic device can make corrections of display lens geometric distortions and chromatic aberrations with IPD and eye relief changes of the eye movements. FIG. 3 at step 354 indicates that as part of distortion and parallax correction from eye movement, the electronic device can adjust display lens geometric distortion correction and chromatic aberration correction with IPD and eye relief changes from eyeball movement. FIG. 9, for example at steps 930-935, provides further detail on display distortion correction, including obtaining the user's IPD changes caused by eyeball movement with eye tracking at step 931, obtaining the user's eye relief changes caused by eyeball movement at step 932, extracting the display lens distortion model with parameters stored on the HMD device at step 933, dynamically making geometric distortion correction with IPD and eye relief changes at step 934, and making chromatic aberration correction with IPD and eye relief changes at step 935.

The electronic device can process the final view frames for display at step 1111. The final view frames can therefore include corrected image data corresponding to the viewpoints of the user's eyes. As described, for example with respect FIG. 2 at step 230, the electronic device can generate the final view frames by blending the final view frames with virtual objects generated by graphics. FIG. 2 at step 240 further describes that the electronic device can render the generated final view frames and display them on display panels. FIG. 3, for example at steps 360-372, provides further detail on final view generating with blending and final view frame rendering, including obtaining the generated final view image from the passthrough pipeline and virtual objects generated by graphics at step 361, blending the final view image and the virtual object together at step 362, rendering the blended frame from the passthrough pipeline at step 371, and displaying the rendered final frame to the display panels at step 372. FIG. 4, for example at steps 440-442, describes final frame generation with distortion correction, including obtaining adjusted head poses with eye poses, IPD change, and eye relief change at step 441, and generating the final frame by reprojecting the see-through frame with adjusted head pose and predicted head pose at step 442.

The integrated process 1100 of FIG. 11 provides significant technical advantages when implemented in a head-mounted device. By combining distortion correction mapping, viewpoint matching mapping, parallax and registration error correction, and displaying lens distortion and chromatic aberration correction into a unified process driven by eye tracking data, the HMD can efficiently produce high-quality final view frames that accurately represent the user's visual perspective. This integrated approach enables real-time compensation for the geometric and optical differences between the see-through cameras and the user's eyes, while also adapting to dynamic changes in eye position and orientation, resulting in a more immersive and visually comfortable video see-through mixed reality experience.

Other disclosed embodiments include a VST head mount device (HMD) that has a housing structure shaped to be worn on a user's head, a pair of external (see-through) cameras coupled to the structure so as to face toward a front side of the structure, a display configured to display an image and/or video to the user wearing the structure, at least one motion sensor (e.g., IMU) positioned inside the structure, at least one depth sensor (e.g., ToF sensor, Lidar) coupled to the structure so as to face toward the front side of the structure, at least one eye-tracking sensor positioned to track the user's eyes. The HMD has a processor operatively connected to the cameras, the display, the motion sensor, the depth sensor, and the eye-tracking sensor. The HMD has a memory operatively connected to the processor.

The HMD can perform a method including collecting data from sensors on the HMD as worn by a user. The data can include see-through images of the user's environment, scene depth data, eye tracking data, and head pose data. The method can include applying a distortion correction mapping for final view frames to present to the user based on the eye tracking data collected while the user looks at different locations on the HMD. The method can include applying a viewpoint matching mapping between viewpoints of see-through cameras used to capture the see-through images and viewpoints of the user's eyes based in part on the eye tracking data. The method can include correcting parallax error and registration error in the final view frames using the eye tracking data. The method can include correcting display lens geometric distortions and chromatic aberrations in the final view frames using the eye tracking data and parameters stored on the HMD. The method can include rendering the final view frames and displaying them to the display panels.

In some cases, applying the distortion correction mapping further can include computing a change in IPD and a change in eye relief corresponding to the eye tracking data, predicting a change between a first head pose when the see-through images are captured and a second head pose when final view frames are displayed to the user, where the prediction is based in part on the change in IPD and the change in eye relief, and reprojecting the see-through image to the final view frames based on the predicted change in head pose.

In some cases, applying the viewpoint matching mapping can include computing a change in eye view depth based on the change in IPD, the change in eye relief, and the scene depth data, generating the viewpoint matching mapping between the viewpoints of the see-through cameras and the viewpoints of the user's eye based on the eye view depth changes, and applying the viewpoint matching mapping to the see-through image to generate the final view frames.

In some cases, correcting the parallax error and the registration error is based the change in IPD, the change in eye relief, and eye view depth changes. In some cases, correcting display lens geometric distortions and chromatic aberrations in the final view frames is based on a distortion model comprising parameters stored on HMD, wherein the distortion model is modified according to the change in IPD and the change in eye relief.

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, input data, wherein the input data includes image data of a scene, eye tracking data, and head pose data;
applying, using the at least one processing device, a distortion correction mapping to the image data based on the eye tracking data to generate final view frames for display;
applying, using the at least one processing device, a viewpoint matching mapping between viewpoints of image data and viewpoints of a user's eyes based in part on the eye tracking data;
correcting parallax error and registration error in the final view frames, using the at least one processing device and the eye tracking data;
correcting display lens geometric distortions and chromatic aberrations in the final view frames, using the at least one processing device and the eye tracking data; and
processing, using the at least one processing device, the final view frames for display on at least one display device.

2. The method of claim 1, wherein applying the distortion correction mapping comprises:
computing a change in interpupillary distance (IPD) and a change in eye relief corresponding to the eye tracking data;
predicting a change between a first head pose when the image data is obtained and a second head pose when the final view frames are processed for display, wherein the prediction is based in part on the change in IPD and the change in eye relief; and
producing the final view frames based on the predicted change between the first head pose and the second head pose.

3. The method of claim 2, wherein the input data further includes scene depth data, and applying the viewpoint matching mapping comprises:
computing a change in eye view depth based on the change in IPD, the change in eye relief, and the scene depth data;
generating the viewpoint matching mapping between the viewpoints of the image data and the viewpoints of the user's eyes based on the change in the eye view depth; and
applying the viewpoint matching mapping to the image data to generate the final view frames.

4. The method of claim 3, wherein correcting the parallax error and the registration error is based on the change in IPD, the change in eye relief, and the change in the eye view depth.

5. The method of claim 3, wherein correcting display lens geometric distortions and chromatic aberrations in the final view frames is based on a distortion model comprising parameters stored on the electronic device, and wherein the distortion model is modified according to the change in IPD and the change in eye relief.

6. The method of claim 1, wherein generating the final view frames comprises:
generating virtual objects by the electronic device; and
blending the generated virtual objects with the image data to generate the final view frames.

7. The method of claim 1, wherein the final view frames include corrected image data corresponding to the viewpoints of the user's eyes.

8. An electronic device comprising:
at least one processing device configured to:
obtain input data, wherein the input data includes image data of a scene, eye tracking data, and head pose data;
apply a distortion correction mapping to the image data based on the eye tracking data to generate final view frames for display;
apply a viewpoint matching mapping between viewpoints of image data and viewpoints of a user's eyes based in part on the eye tracking data;
correct parallax error and registration error in the final view frames, using the eye tracking data;
correct display lens geometric distortions and chromatic aberrations in the final view frames, using the eye tracking data; and
process the final view frames for display.

9. The electronic device of claim 8, wherein, to apply the distortion correction mapping, the at least one processing device is configured to:
compute a change in interpupillary distance (IPD) and a change in eye relief corresponding to the eye tracking data;
predict a change between a first head pose when the image data is obtained and a second head pose when the final view frames are processed for display, wherein the prediction is based in part on the change in IPD and the change in eye relief, and
produce the final view frames based on the predicted change between the first head pose and the second head pose.

10. The electronic device of claim 9, wherein the input data further includes scene depth data, and to apply the viewpoint matching mapping, the at least one processing device is configured to:
compute a change in eye view depth based on the change in IPD, the change in eye relief, and the scene depth data;
generate the viewpoint matching mapping between the viewpoints of the image data and the viewpoints of the user's eyes based on the change in the eye view depth; and
apply the viewpoint matching mapping to the image data to generate the final view frames.

11. The electronic device of claim 10, wherein correcting the parallax error and the registration error is based the change in IPD, the change in eye relief, and the change in the eye view depth.

12. The electronic device of claim 10, wherein correcting display lens geometric distortions and chromatic aberrations in the final view frames is based on a distortion model comprising stored parameters, and wherein the distortion model is modified according to the change in IPD and the change in eye relief.

13. The electronic device of claim 8, wherein, to generate the final view frames, the at least one processing device is configured to:
generate virtual objects; and
blend the generated virtual objects with the image data to generate the final view frames.

14. The electronic device of claim 8, wherein the final view frames include corrected image data corresponding to the viewpoints of the user's eyes.

15. A non-transitory machine readable medium containing instructions that when executed cause at least one processor of an electronic device to:
obtain input data, wherein the input data includes image data of a scene, eye tracking data, and head pose data;
apply a distortion correction mapping to the image data based on the eye tracking data to generate final view frames for display;
apply a viewpoint matching mapping between viewpoints of image data and viewpoints of a user's eyes based in part on the eye tracking data;
correct parallax error and registration error in the final view frames, using the eye tracking data;
correct display lens geometric distortions and chromatic aberrations in the final view frames, using the eye tracking data; and
process the final view frames for display.

16. The non-transitory machine readable medium of claim 15, wherein the instructions that when executed cause the at least one processor to apply the distortion correction mapping comprise instructions that when executed cause the at least one processor to:
compute a change in interpupillary distance (IPD) and a change in eye relief corresponding to the eye tracking data;
predict a change between a first head pose when the image data is obtained and a second head pose when the final view frames are processed for display, wherein the prediction is based in part on the change in IPD and the change in eye relief; and
produce the final view frames based on the predicted change between the first head pose and the second head pose.

17. The non-transitory machine readable medium of claim 16, wherein the input data further includes scene depth data, and the instructions that when executed cause the at least one processor to apply the viewpoint matching mapping comprise instructions that when executed cause the at least one processor to:
compute a change in eye view depth based on the change in IPD, the change in eye relief, and the scene depth data;
generate the viewpoint matching mapping between the viewpoints of the image data and the viewpoints of the user's eyes based on the change in the eye view depth; and
apply the viewpoint matching mapping to the image data to generate the final view frames.

18. The non-transitory machine readable medium of claim 17, wherein correcting the parallax error and the registration error is based the change in IPD, the change in eye relief, and the change in the eye view depth.

19. The non-transitory machine readable medium of claim 15, wherein correcting display lens geometric distortions and chromatic aberrations in the final view frames is based on a distortion model comprising stored parameters, and wherein the distortion model is modified according to the change in IPD and the change in eye relief.

20. The non-transitory machine readable medium of claim 15, wherein the instructions that when executed cause the at least one processor to generate the final view frames comprise instructions that when executed cause the at least one processor to:
generate virtual objects; and
blend the generated virtual objects with the image data to produce the final view frames.
